(19) United States
(12) Patent Application Publication
(10) Pub. No.: US 2003/0128239 A1
(43) Pub. Date: Jul. 10, 2003

(54) Method and apparatus for XML schema publishing into a user interface

(75) Inventors: Vaishali Angal, Sunnyvale, CA (US); Sandeep Nawathe, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: Full Degree, Inc., Palo Alto, CA

(21) Appl. No.: 10/033,657

(22) Filed: Dec. 27, 2001

(51) Int. Cl. G09G 5/00; G06F 15/00

(52) U.S. Cl. 345/762; 715/513

(57) ABSTRACT

A method and apparatus for automating the creation of user interface screens by using an XML schema that defines the data to be presented and then using a display specification that defines how the data should be presented are disclosed.

### FIELD OF THE INVENTION

The present invention pertains to a user interface for well formed data structures. More particularly, the present invention relates to a method and apparatus for XML schema publishing into a user interface.

### BACKGROUND OF THE INVENTION

Many companies are adopting the use of XML (extensible Markup Language) for a variety of applications, such as, structured documents, data on the web, data in databases, etc. Additionally, there is the presentation of such information to a user via a UI (User Interface). However, in the past the presentation of data and/or the creation of the UI screens has been specifically coded with knowledge of the data and UI presentation being taken into account. This specific coding presents problems when the data and/or the format of the data changes, the schema changes, and/or the presentation of such to the user is to be changed.

Part of any ‘n tier software application’ involves creating a database structure based on a specific set of attributes for a client, mapping those specific attributes to a user interface, and presenting the information in a format that allows the user to view and manage the content being displayed. A possible problem with this approach is that every client usually has a different way of compiling information thus making the development of a standard User Interface almost impossible. This problem becomes even more apparent when addressing product information. Not only are there thousands of products, but there are thousands of different ways that products can be described.

In today's world, enterprise applications may have hundreds of user interface screens to make up the application. User screens are used to display product information, allow system administration, show workflow, provide reporting, etc. Additionally, there may be many variations in screen displays, due in part to every business viewing their information in different ways. Maintaining the details of the different screens and updating or customizing screen displays can be a horrendous task and can take enormous amounts of time. Customizations are hard to do and often require both user interface and database programmers to make even the simplest of changes.

### BRIEF DESCRIPTION OF THE DRAWINGS

The present invention is illustrated by way of example and not limitation in the figures of the accompanying drawings, in which like references indicate similar elements and in which:

FIG. 1 illustrates a network environment in which the system and method of the present invention may be implemented;

FIG. 2 is a block diagram of a computer system;

FIG. 3 illustrates one embodiment of the present invention;

FIGS. 4A and 4B illustrate one embodiment of a schema;

FIGS. 5A and 5B illustrate another embodiment of a schema;

FIGS. 6A and 6B illustrate one embodiment of a data instance;

FIGS. 7A and 7B illustrate unhiding and hiding;

FIG. 8 illustrates one embodiment of a display specification;

FIG. 9 illustrates another embodiment of a display specification;

FIG. 10 illustrates one embodiment of a display;

FIG. 11 illustrates another embodiment of a display;

FIG. 12 illustrates a well formed document;

FIG. 13 illustrates one embodiment of a list display;

FIG. 14 illustrates one embodiment of a tree display;

FIG. 15 illustrates one embodiment of a form display;

FIG. 16 illustrates one embodiment of a tab display;

FIG. 17 illustrates one embodiment of a combination tab and form display; and

FIG. 18 illustrates one embodiment of a tree structured database.

### DETAILED DESCRIPTION

A method and apparatus for XML schema publishing into a user interface are described.

The present invention automates the creation of User Interface (UI) screens (or displays) by using an XML schema that defines the data to be presented and then using a display specification(s) (also denoted display spec(s)) that defines how the data should be presented. XML schemas can be used to describe any type of data, product, individual, attribute, or piece of information, etc. Display specs may be used to create the screens used to make up any type of application, applet within a web page, display screen, etc. By automating the creation of UI screens, software solutions may be built faster and/or cheaper. Such software solutions include, for example, Product Information Management (PIM) applications, Human Resource (HR) applications, E-commerce solutions, Customer Relations Management (CRM) solutions, Enterprise Resource Planning (ERP) solutions, or any other type of solution that involves building a user interface to display a piece of information, function, workflow, etc.

The present invention automates screen creation using an XML schema that is used to define the data, and a display specification that defines how the data should be presented. This allows clients to create almost any instance of a schema for a product, or piece of information, and have the User Interface screens automatically generated without additional programming. Once the initial screen is built, an application user may add comments or text to the item being displayed, add or delete features, add or delete fields, and be able to display the changes automatically. By saving such changes, the updates are automatically read into the screen creation next time the product is reviewed.

This automation dramatically reduces the programming time required to create new applications, and may make customizing easier and faster. Once a product is implemented, the present invention allows users to easily make changes to information and information structures being displayed, save changes, and redisplay changes without re-programming the User Interface or touching the database.

For example, a file containing the product specifications used to describe a running shoe could be stored in a native XML format that self describes the product. The file could be combined with a display specification that would instruct how that product information should be displayed, and automatically generate the user screen so that the user could read the product spec, make changes, add new attributes, and save and/or publish a report on the product, etc.

A benefit to the client may include that separate user interface screens do not need to be pre-designed for each type of product, and do not need to be mapped to the database. This approach greatly reduces the engineering time needed to create the application.

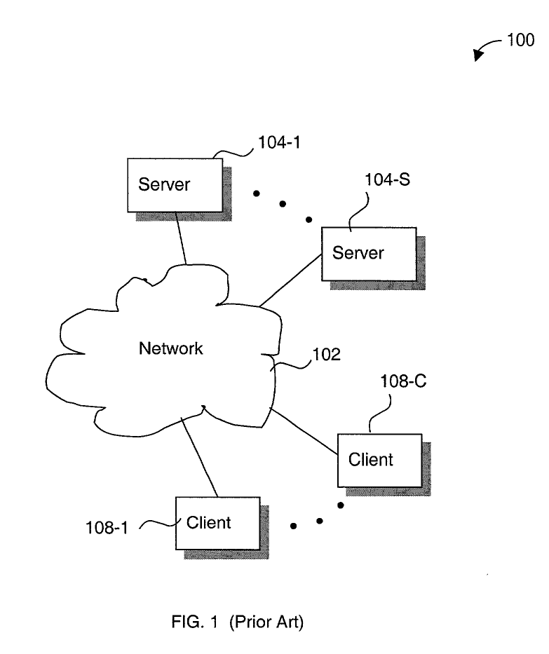

FIG. 1 illustrates a network environment 100 in which the techniques described may be applied. The network environment 100 has a network 102 that connects S servers 104-1 through 104-S, and C clients 108-1 through 108-C. More details are described below.

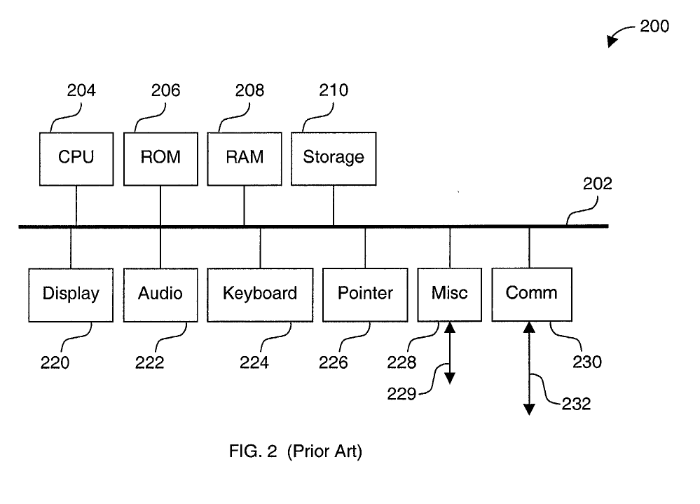

FIG. 2 illustrates a computer system 200 in block diagram form, which may be representative of any of the clients and/or servers shown in FIG. 1.

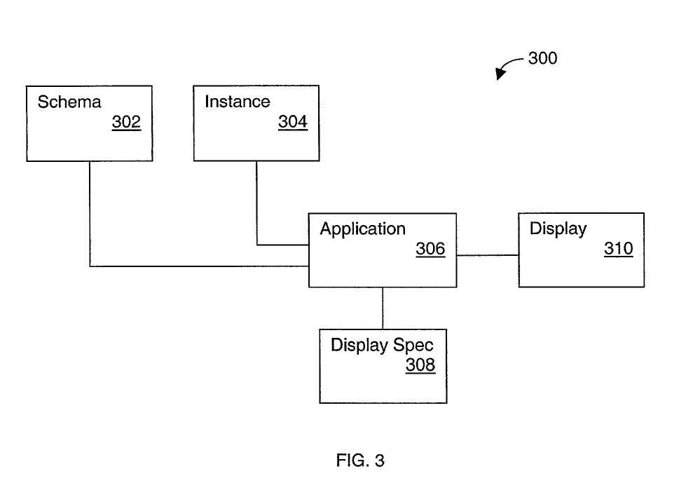

FIG. 3 illustrates in block diagram form one embodiment of the present invention 300. In this embodiment, a schema 302 represents the format for data. One instance of data is illustrated at 304. At 308 is a display specification (display spec). At 308 is an application that interfaces with the schema 302, the instance 304, the display spec 308, and generates a display 310. The display 310 may have a visual presentation with capability for user input. Thus, the display 310 may be editable by a user, for example, display 310 may be, but is not limited to, a monitor and keyboard.

The display spec 308 as presented in the present invention allows for flexibility. For example, schemas, as exemplified by 302 are often not static but dynamic and evolving. Thus, the display spec allows for extensibility of data structures, allows for structure of the data changing, and yet the system for how to present the information does not need to change. This display spec flexibility is based, in one embodiment, on “presenters”. A presenter is a user interface widget associated with a schema element. The display spec can directly support all XML namespaces. Additionally, the display spec uses the schema and so does not need to rely on a data instance.

An example of presenters may be, but is not limited to, a list presenter, a tree presenter, a tabbed presenter, and a form presenter. Presenters may also be nested or embedded into each other, so combinations such as a tree presenter having within it a list presenter is possible. Additionally, such niceties as horizontal line separators, font styles, text sizes, etc. may be specified. That is, while an XML structure may be tree based, the use of presenters, may for example, display the information in a list format.

In another embodiment, the display specification may also specify actions and operations. These allow for the capability to receive user input and perform actions. For example, a display spec may show in a list box a URL to a web site. By using actions and operations, the website may be displayed when the user clicks on the URL link. Thus, the display spec supports interaction with the user.

Another example of an action may be, for example, the user clicking on a button to view an image of a product. The action in this example, may be to find a rendering engine that can show the image.

Other examples of an action that may be in a presenter in the display spec include: the scenario where the user wishes to change a displayed node value, for example, a text description; a button in the display spec to do a further action, such as, update, delete, send an email, printout a page, listen to a sound, etc.; lookup information in a table and/or select the information, transfer a payment and/or credit, etc.

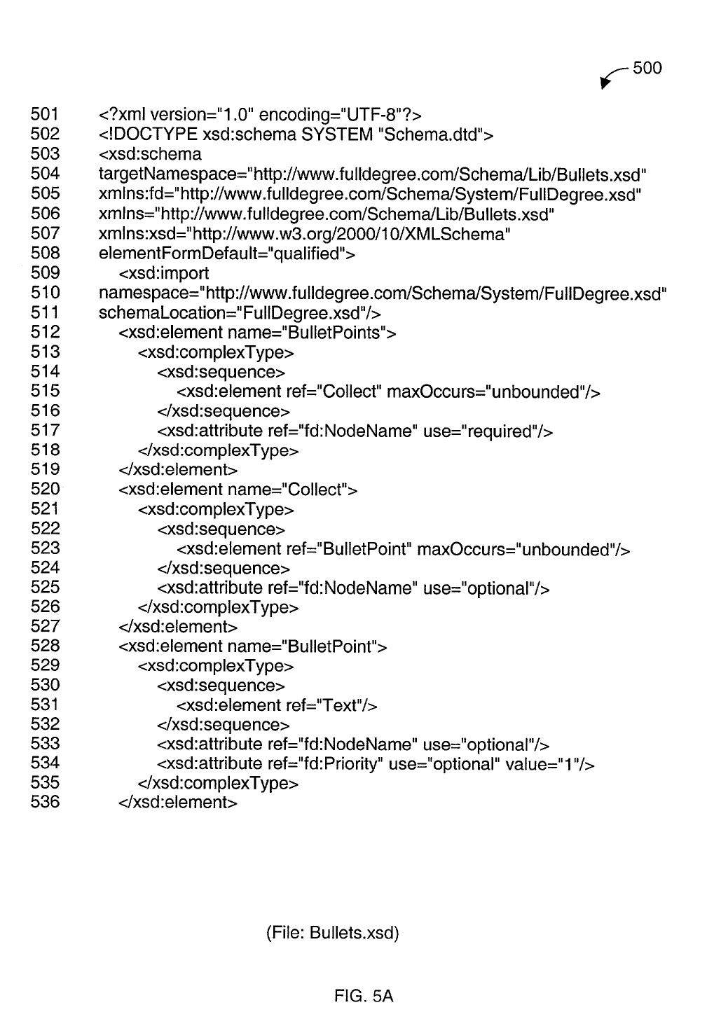

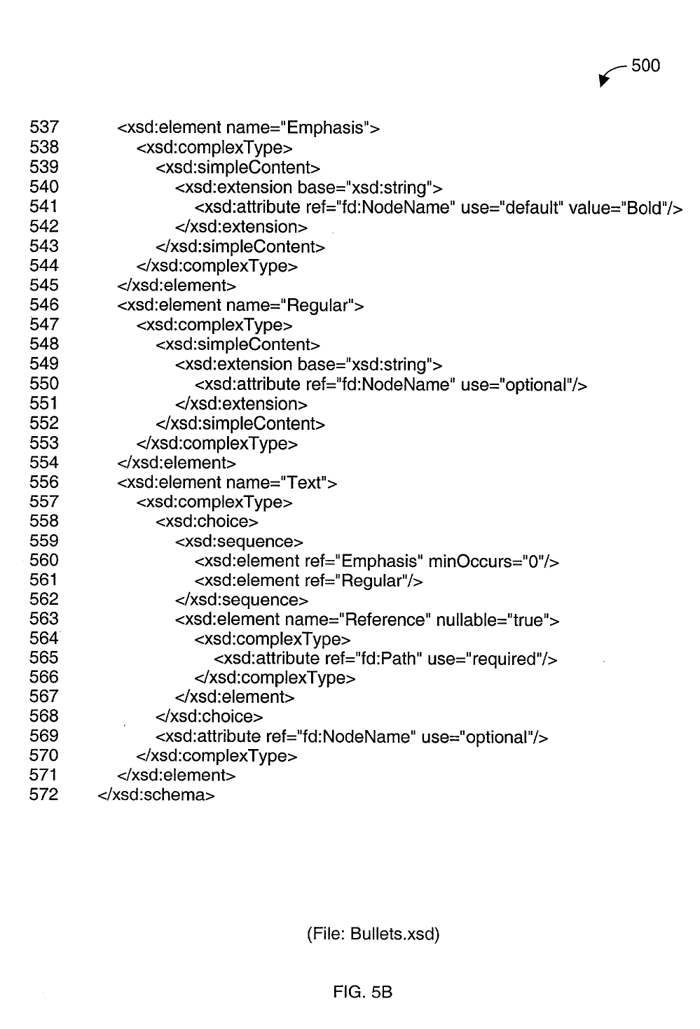

In another embodiment, the display spec may provide support for what information to display and what information should not be displayed. This may be useful where one user needs access to, for example, full product information and the ability to display and change the manufacturer's product price, whereas another user, such as a customer, should not be allowed to see manufacturer's price but only the product information and the manufacturer's suggested retail price (MSRP). This functionality is provided, for example, in a tree structured database, by the ability to hide a node, hide children node(s), hide all nodes, provide overrides, etc. The display spec support includes the ability to support selective hiding and/or overriding of elements and sub-elements, etc. For example, consider the display of Bullet Points in a Form-Presenter. The schema for bullet points is described in FIG. 6A. The line <ElementD Name=“Text” Hide=“true”/>in the display spec would hide the child node called “Text” of the bulletpoint. FIG. 7A screen-shot 700 shows the child node “Text” 702 displayed. With the Hide=true statement above in the display spec the FIG. 7B screen shot 720 results and no “Text” is seen.

Selectors can be used to qualify elements in the display spec over and above their namespaces. The normal case of xmlns:Tagname is supported as is any:Tagname, any:any (also the shorthand *:*), and xpath language support. When specified for an ElementD, it means that a selector will match “any” element with the specified Tagname. The “any” keyword is specified in the following manner within the display spec DisplaySpecD Tag.

<DisplaySpecD . . .

xmlns:any=http://www.fulldegree.com/Schema/Reserved/ReservedAny.xsd>

For example, below is usage of “any” to qualify an element. The following line will match any element with tagname container, irrespective of its namespace.

<ElementD Name=“any:Container” Hide=“true”>

any:any—Applies to all the Elements

example: <ElementD Name=“any:any” FontStyle=“Bold”/>

ns:any—Applies to all the elements within the “ns” namespace

example: <ElementD Name=“beans:any” FontStyle=“Bold” Align=“left”/>

Note that any ElementD appearing after the above specifications in a display spec, will override the behavior specified with “any”.

The display spec in another embodiment provides support for order precedence and/or inheritance for displaying items, for example, text labels. For example, the order of precedence for display is: Node Name, Name, and then Tag Name. Thus, if an element has a parameter:

<Color Name=“722” NodeName=“Marine Blue”/>

then the text “Marine Blue” would be displayed. On the other hand, if the element is:

<Color Name=“722”/>

then the text “722” would be displayed. Finally, if the element only had:

<Color/>

then the text “Color” would be displayed.

One skilled in the art will appreciate that this mechanism provides an easy approach to change, even globally, what will be displayed. For example, rather than displaying “MSRP” such instances may be changed to “Price” by the following.

<MSRP Prefix=“$” NodeName=“Price:”>2.99</MSRP>

However, the scope of such a change may be controlled by the namespace. That is the display spec acts on tag names in a given namespace. This allows, for example, different manufacturesrs to “override” what the user interface may show. So, for example if MSRP is “overridden” as above and we have:

<ElementD Name=“MSRP”/>

then the result displayed under a UI would be:

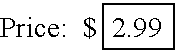

Without the override i.e, <MSRP Prefix=“$”>2.99</MSRP>, the UI display would be:

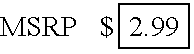

The label for an element can be specified as a ‘Source’. The Source may point to any other element's nodename/name/tagname or its value. For example, if the parent of the element Component has the FormPresenter, then the following lines in the display spec:

<ElementD Name=“ns:Colors” Edit=“true” displayNamespace=“.”>

<Presenter Name=“Colors”

ObjectName=“com.fulidegree.display.presenters.UnindentedFormPresenter”>

<ElementD Name=“ns:Component” LabelSource=“Component. Item.#TEXT”>

<ElementD Name=“ns:Item” Hide=“true”/>

will yield the result:

Canopy Color: Blue

on the form where the word “Canopy” is the value of the XML element, “Component/Item”

For the following Instance:

<Colors>

<Component>

<Item>Canopy</Item>
<Color>Blue</Color>

</Component>

</Colors>

Because the display spec provides support for all namespaces, similarly named elements in different namespaces may have different display attributes associated with them. For example the element “Name” may be used to denote both a person's name and a company's name in different namespaces. However, in a display spec we may want to make the person's name bold, but not the company's name. This is accomplished by referencing bold in the person's namespace only. For example:

<ElementD Name“PersonName:Name” FontStyle=“Bold”/>

would result in bold being applied to the PersonName namespace. Thus, it is to be understood that the display spec supports XML namespaces and multiple namespaces, follows the same syntax, and supports qualification for a namespace. As was indicated above, the display spec acts on tagnames in a given namespace. Additionally, the display spec provides support for multiple display spec namespaces as well.

In addition to support for tree structured databases, such as XML, the display spec also supports the concept of softlinks (also denoted soft links), where several nodes may point to the same node. Thus, the display spec supports directed graph structures. That is, the elements do not have to be in a tree structure as far as the display spec is concerned, they only need to have a parent child relationship. Thus, a node may have more than one parent.

The display spec also provides XML support for extra elements that may not yet be in the schema and/or instance. These extra fields may be coded for in advance of the schema being modified. The display spec provides support for empty instances, including schema choices, and schema having the + or * specified for an element.

The display spec also supports include capability. Whereas XML only allows includes within the schema and not the instance, the display spec supports includes within a display spec. Thus, a display spec can include another display spec.

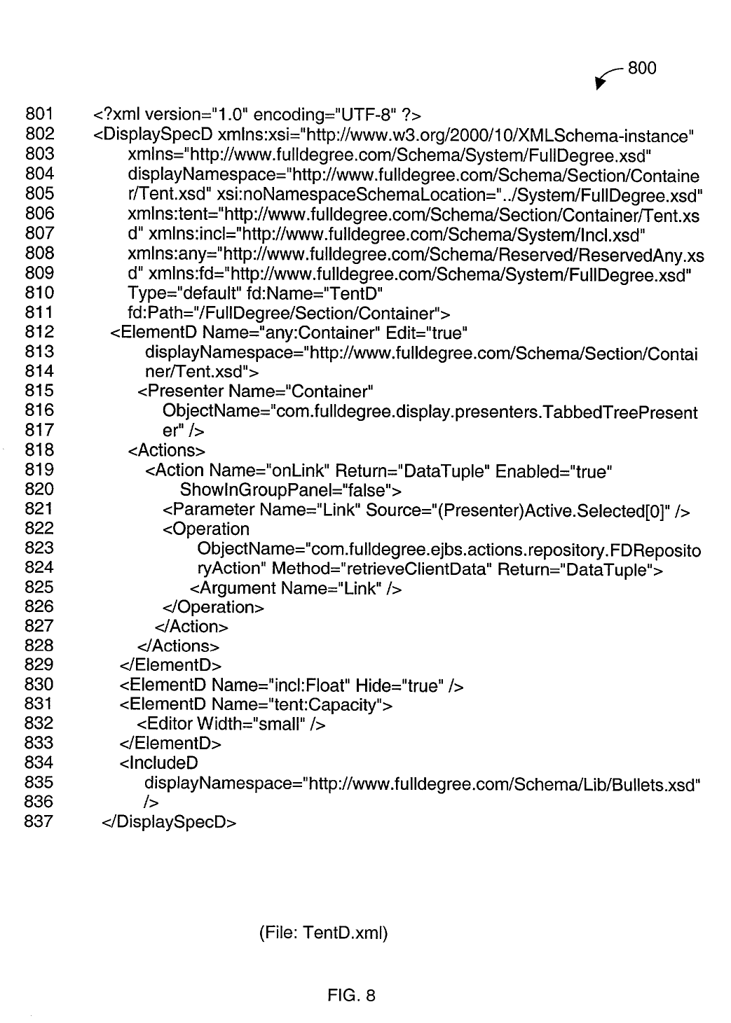

Referring now to FIG. 12 is a well-formed document 1200 “doc” having subelements (which may also be referred to as children, nodes, subnodes, etc.) “aaa”, “bbb”, “ccc”, and “ddd”. It will also be noted that node “bbb” has subnodes “b1” and “b2”, and that subnode “b2” has an element value “bb”.

A display spec requesting a list presentation of doc, for example, via:

<ElementD Name=“doc” Presenter=“List”/>

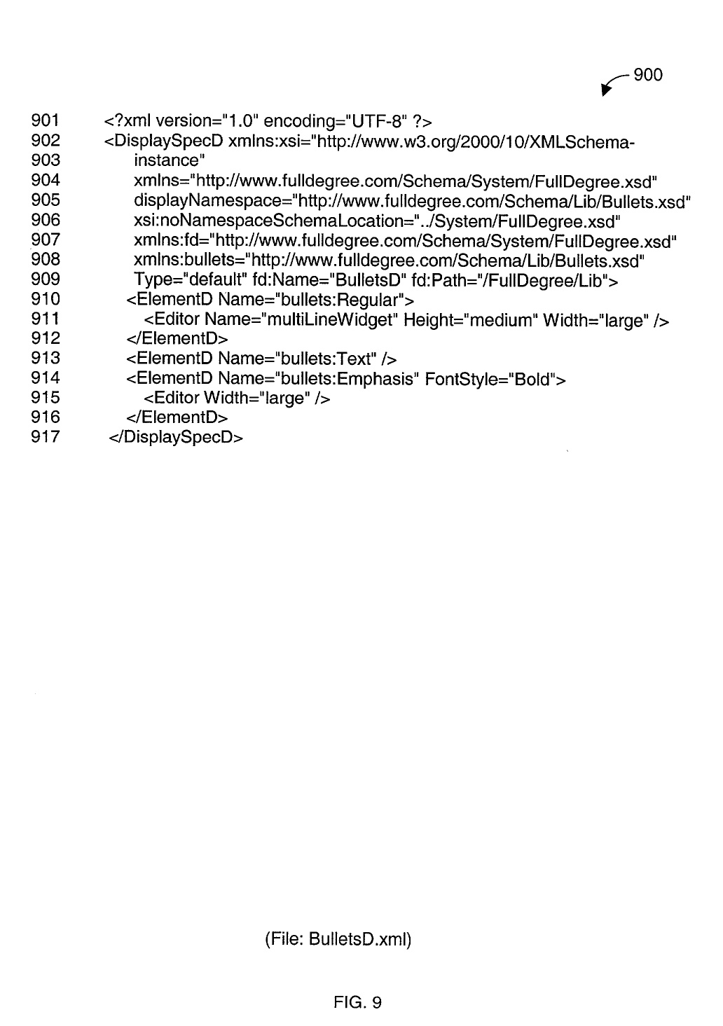

might result in the list display as illustrated 1300 in FIG. 13.

A display spec requesting a tree presentation of doc, for example, via:

<ElementD Name=“doc” Presenter=“Tree”/>

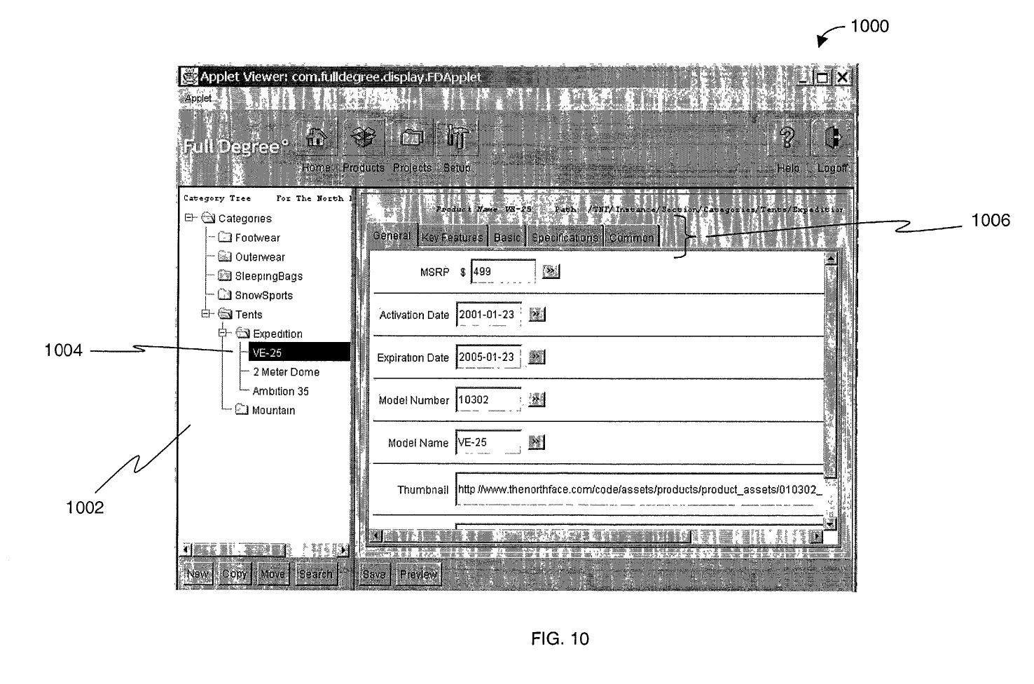

might result in the tree display as illustrated 1400 in FIG. 14. Here doc is shown as the top root and only the first children (aaa, bbb, ccc, and ddd) are displayed.

A display spec requesting a form presentation of doc, for example, via:

<ElementD Name=“doc” Presenter=“Form”/>

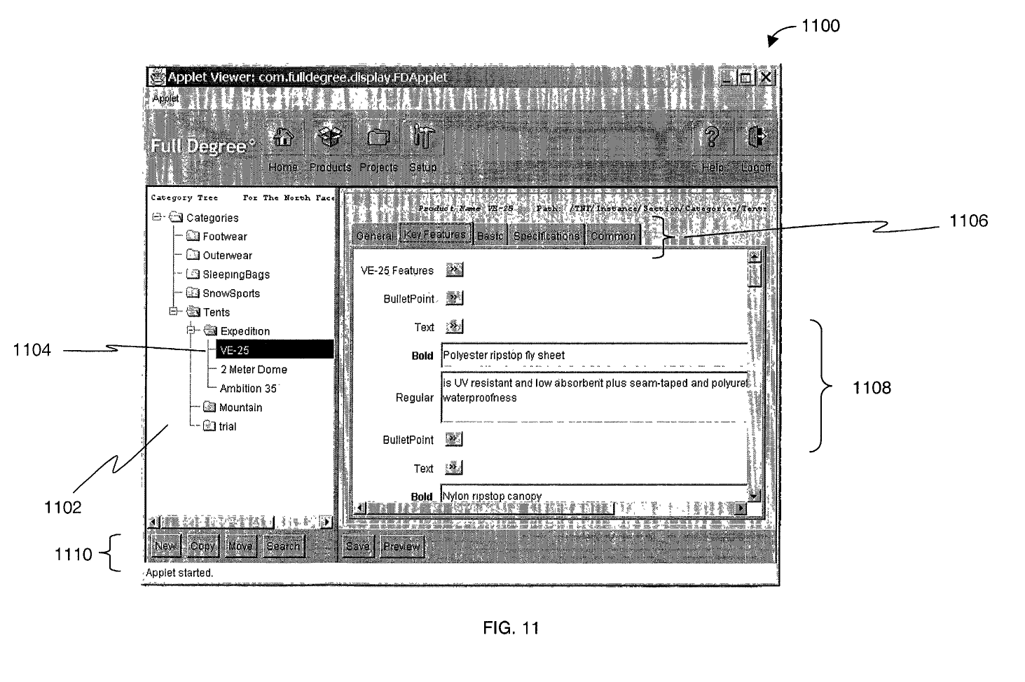

might result in the form display as illustrated 1500 in FIG. 15. Here the first children of doc are shown and a form box 1502 is adjacent to the children showing any immediate value of the child. Here, none of the children (aaa, bbb, ccc, and ddd) has an immediate value, and so the form box is vacant.

A display spec requesting a tab presentation of doc, for example, via:

<ElementD Name=“doc” Presenter=“Tab”/>

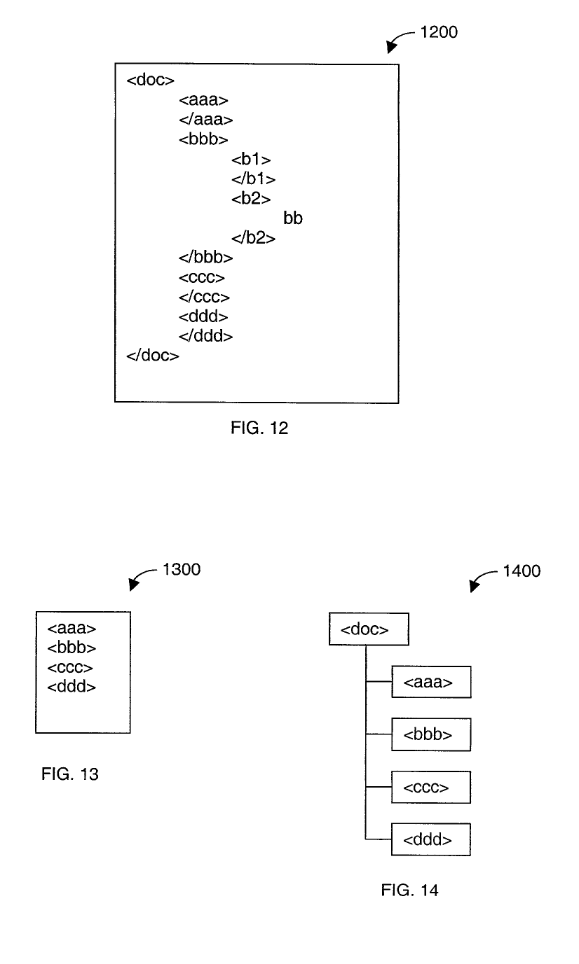

might result in the tab display as illustrated 1600 in FIG. 16. Here the tabs 1602 are each labeled with the name of the first children (aaa, bbb, ccc, and ddd). The selected tab entry, here aaa, also has an associated display area 1604.

A display spec requesting a tab presentation of doc, and form presentation of bbb, for example, via:

<ElementD Name=“doc” Presenter=“Tab”/>

<ElementD Name=“bbb” Presenter=“Form”/>

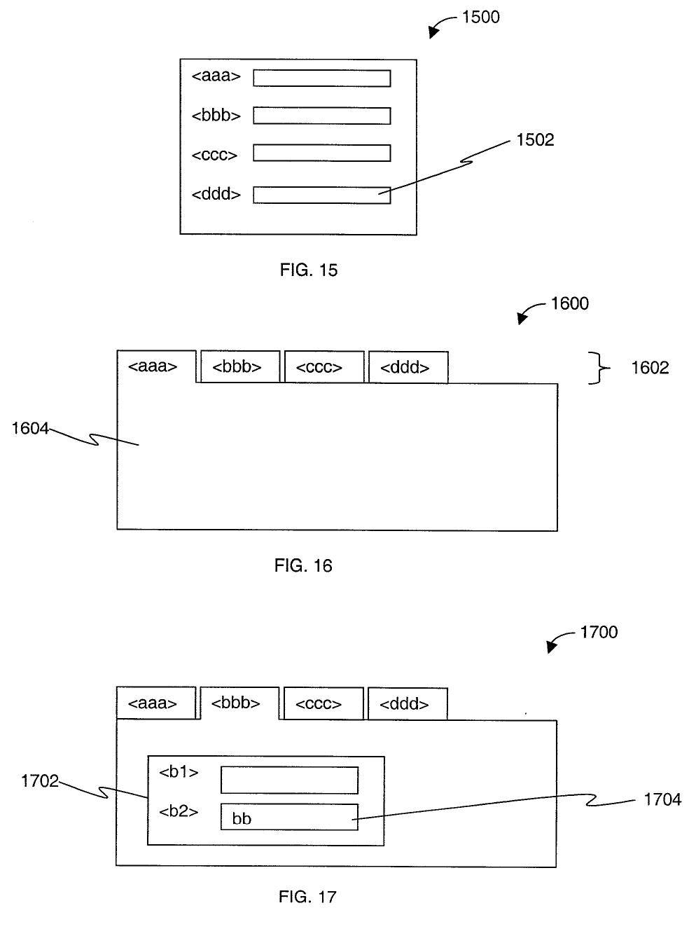

might result in the display as illustrated 1700 in FIG. 17. Here the tab bbb is selected and 1702 is the form presentation. The form presenter shows the children of bbb as b1 and b2 and the box form 1704 shows the value of bb for b2.

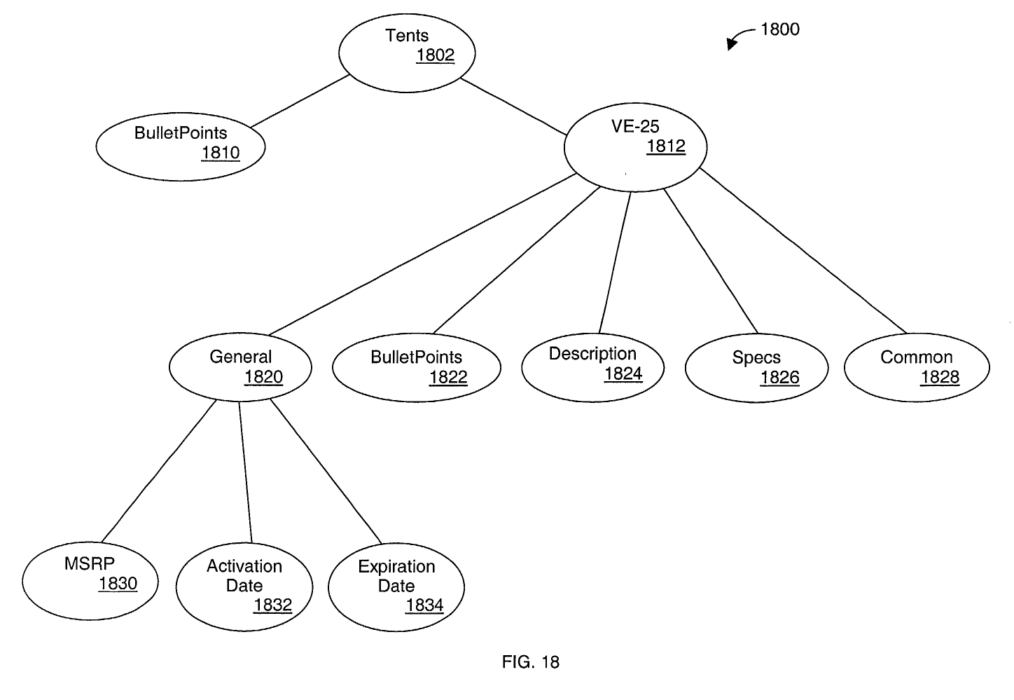

FIG. 18 illustrates a tree structure 1800 of a database. The top node is Tents 1802. Tents 1800 may be considered a category in a database. The children of Tents are BulletPoints 1810 and VE-25 1812. VE-25 1812 may be considered a container for the nodes beneath it (i.e. 1820-1834) and, for example, a specific instance of a tent.

VE-25 has children General 1820, BulletPoints 1822, Description 1824, Specs 1826, and Common 1828. General 1820 has children MSRP 1830, Activation Date 1832, and Expiration Date 1834. Each node may have associated information, for example, Tents 1802 may have data related to all tents. Bulletpoints 1810 may have information related to all Tents 1802. VE-25 1812 may have information related to the VE-25 series of tent. General 1820 may have general information and the children may supply additional information. For example, MSRP 1830 may contain the manufacturer's suggested retail price, 1832 may contain the Activation Date, and 1834 the Expiration Date. 1822 may contain BulletPoints related to VE-25, while 1824 has a Description, 1826 the Specs, and 1828 Common items, such as warranty, etc. Thus one is to appreciate that the tree structure 1800 is well formed and so may for example, be representative of an XML structure.

The namespace support described above may be illustrated using FIG. 18. For example, the following:

<ElementD Name=“any:any” hide=“true”/>

would result on all the nodes of FIG. 18 not being displayed. On the other hand, if the following were added to the display spec having the statement above:

<ElementD Name=“Tents:General” hide=“false”/>

then the node General 1820 alone would be displayed.

If in FIG. 18, we wanted to display BulletPoints 1810 and not display BulletPoints 1824 then the following statement (an xpath example) in the display spec would do this.

<ElementD Name=“//Tents/General/BulletPoints” hide=“true”/>

To illustrate in greater detail some of the aspects of the present invention, one exemplary embodiment showing some actual code will be illustrated. To avoid confusion and/or obscuring of the present invention, the files and code examples may be incomplete, however, one skilled in the art will appreciate that what is disclosed in the illustrations conveys enough information to practice the present invention without undue experimentation.

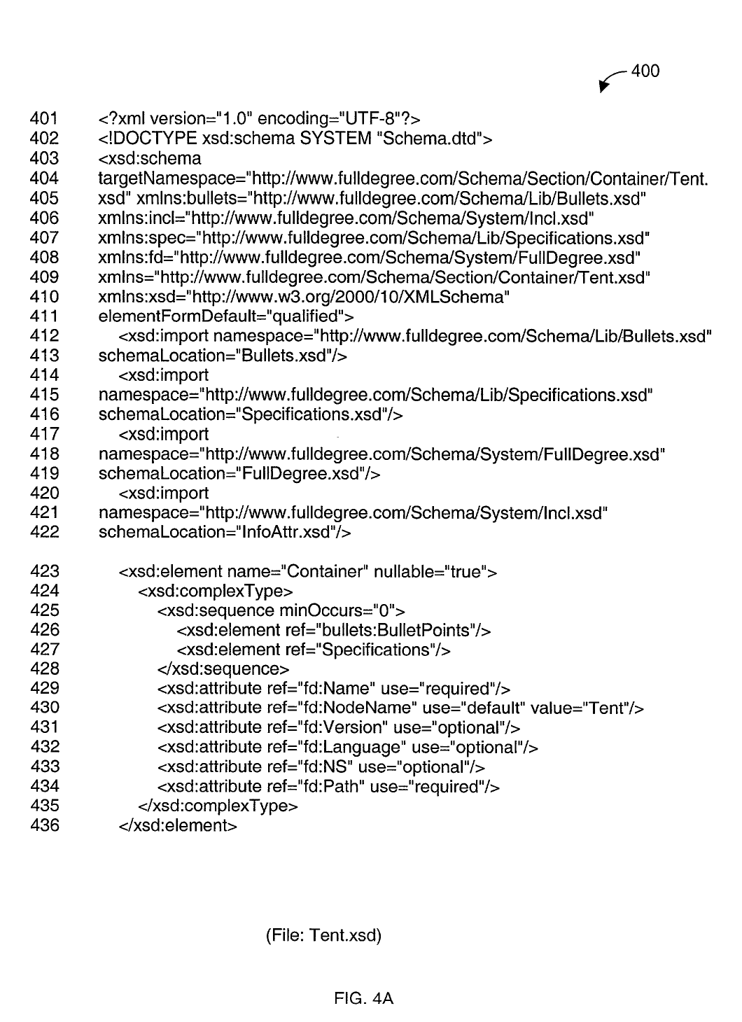

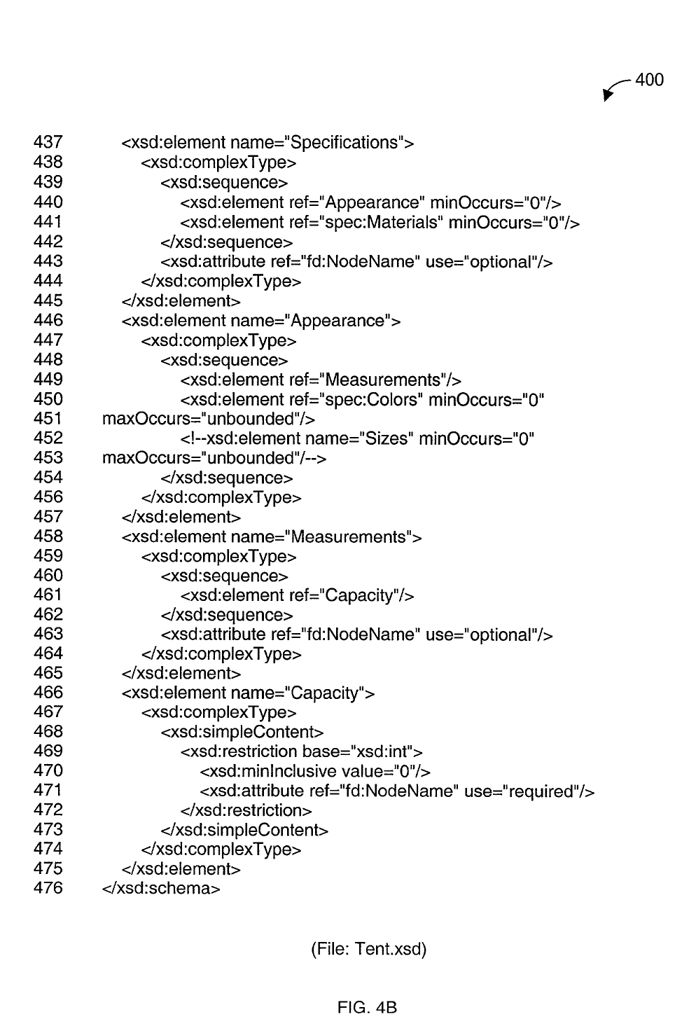

FIGS. 4A and 4B illustrate an embodiment 400 of a schema in a file called Tent.xsd. 400 is a well formed XML schema. At 401 is denoted the current XML version. Tent.xsd is specified as a target namespace (targetNamespace at 404-405) and as an XML namespace (xmisns at 409). Reference is also made to a file Bullets.xsd at 405 and 409. One embodiment 500 of the file Bullets.xsd is illustrated in FIGS. 5A and 5B.

FIGS. 6A and 6B illustrate one embodiment 600 of a data instance in a file VE-25.xml. Reference is made to Tent.xsd at 606 and 613, and reference is made to Bullets.xsd at 609.

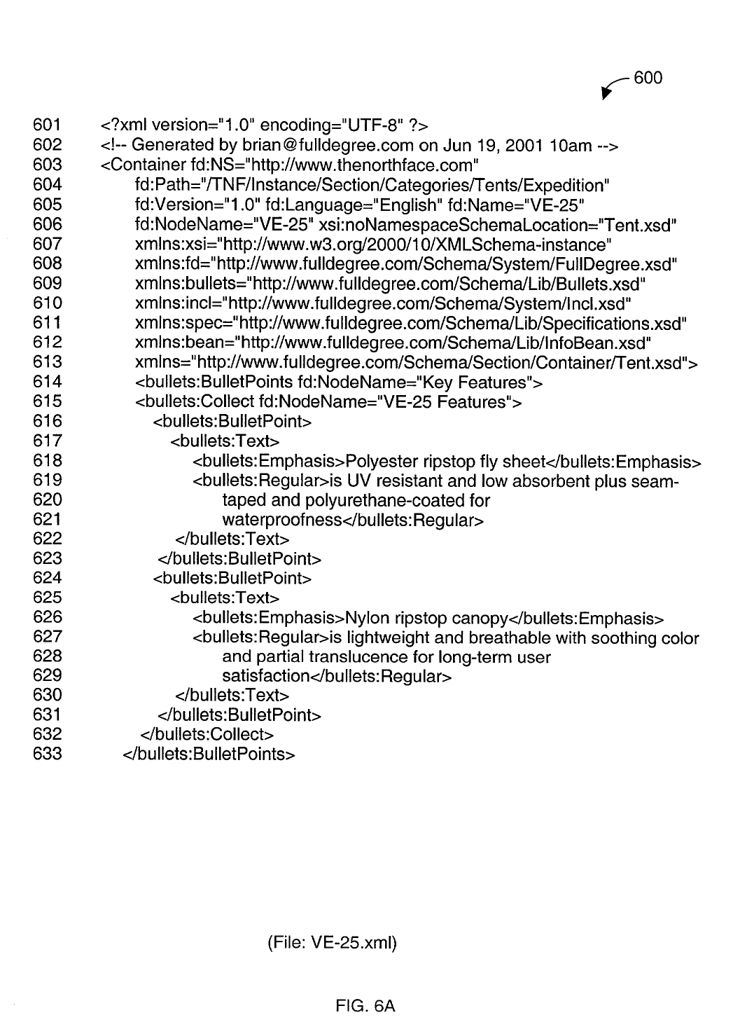

FIG. 8 illustrates one embodiment 800 of a display spec in a file TentD.xml. The display spec is denoted by the tag DisplaySpecD (at 802 and 837). Reference is made to Tent.xsd at 805, 806-807, and 814. Reference to Bullets.xsd is made at 835. Note that at 815 a tag Presenter is present, and that at 818 a tag Actions exists. The Presenter tag at 815 has a name Container and the ObjectName 816 references a “.TabbedTreePresenter” 816-817. Actions at 818 has an Action named “on Link” at 819. As was noted above, the display spec may provide support for what information to display and what information should not be displayed. Here, at 830 Hide=“true” is an example of information that will not be displayed.

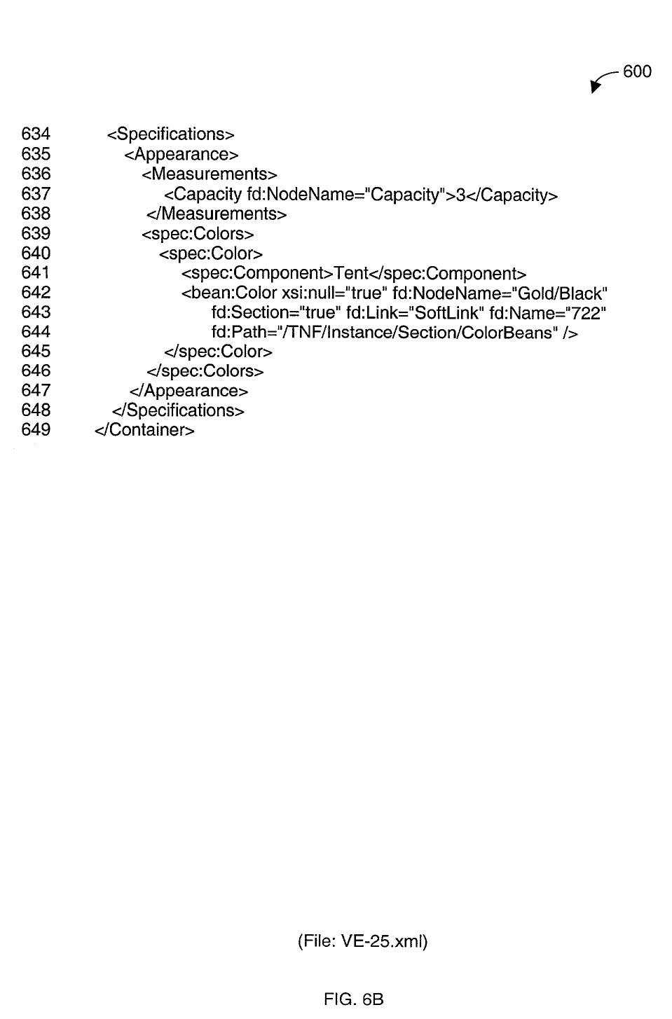

The display spec illustrated at 800 does not make an explicit reference to the display spec file BulletsD.xml, however, one skilled in the art will recognize that a method and system may be implemented to search first for a related named display spec before using a default. Such is the case as illustrated here. FIG. 9 illustrates one embodiment 900 of a display spec (in a file named BulletsD.xml) that may be used to display Bullets.xsd. Reference to Bullets.xsd is made at 905 and 908, thus a search for a display spec would yield a reference that indicates that this display spec may be used for displaying Bullets.xsd. Note also, that the tag ElementD 910 references a name with bullets:Regular at 910. Additionally 911 illustrates a multiLineWidget with parameters set for Height and Width. 913 illustrates Bullets:Text and 914 shows bullets:Emphasis further defining a FontStyle of Bold, and an Editor Width being large.

Referring back to FIG. 3, files Tent.xsd and Bullets.xsd (FIGS. 4 and 5 respectively) might represent the schema 302. VE-25.xml (FIGS. 6A and 6B) might represent a data instance 304. Files TentD.xml and BulletsD.xml (FIGS. 8 and 9 respectively) might represent a display spec 308. An application 306 may make use of these (302, 304, 308) and generate a display 310.

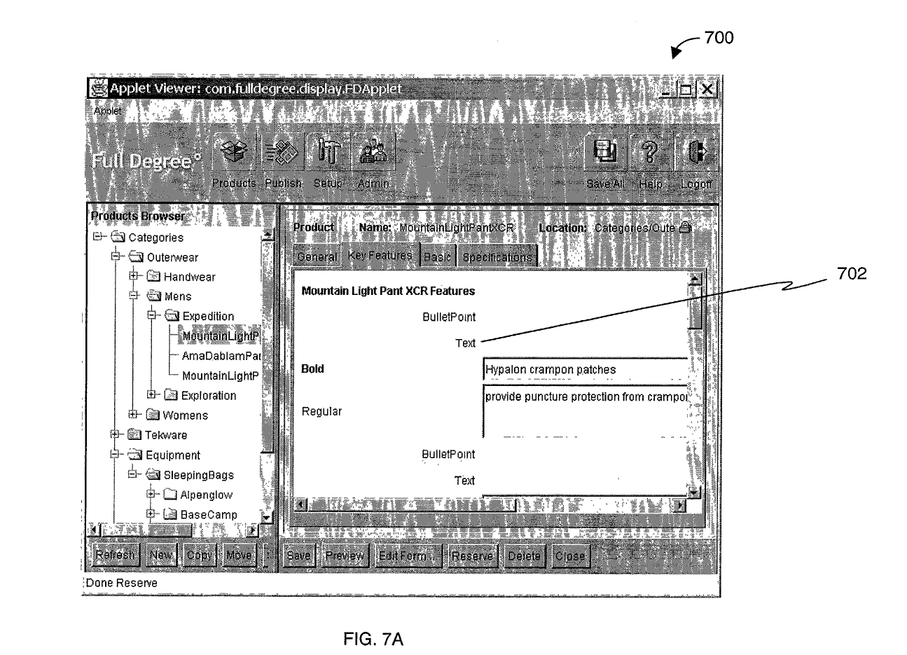

FIG. 10 illustrates one embodiment of a display 1000 that might be generated. A tree display of information is shown in panel 1002. The entity selected VE-25 is denoted as illustrated at 1004. In another panel is a tabbed presentation 1006. The currently displayed tab is labeled “General”. Other tabs are Key Features, Basic, Specifications, and Common.

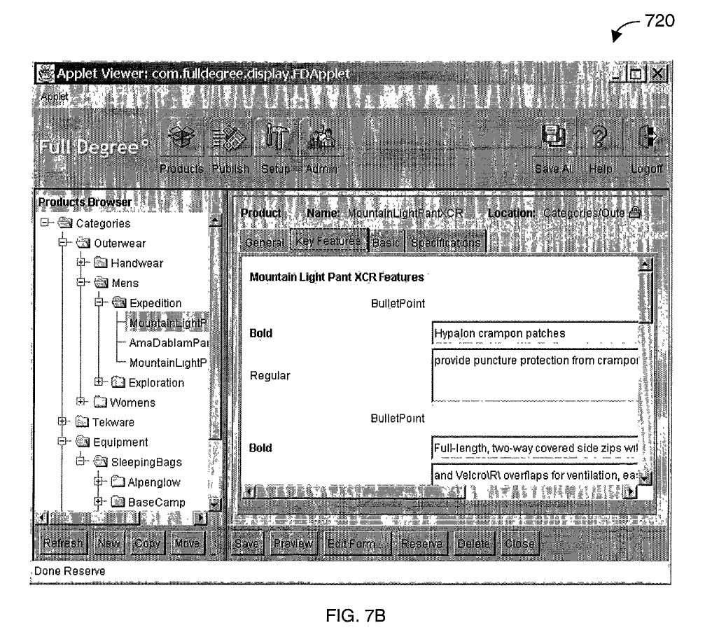

FIG. 11 illustrates another embodiment of a display 1100 that might be generated. Here there is a tree display of information in panel 1102. The entity selected VE-25 is denoted as illustrated at 1104. In another panel is a tabbed presentation 1106. The currently displayed tab is labeled “Key Features”. Other tabs are General, Basic, Specifications, and Common. At 1108 is shown Text, Bold, Regular, and BulletPoint. For example, Bold has the text “Polyester ripstop fly sheet.” One skilled in the art will recognize that this Key Feature came from 614, and the text came from 618. The Bold came from the attribute bullets:Empahsis 618 and was rendered per the display spec 914 with the FontStyle=“Bold”.

FIG. 11 also illustrates at 1110 some displayed buttons. The buttons at 1110 may be associated with actions that the user may activate. Actions may have operations (see FIG. 8, 818-828).

From this example, one is to appreciate that the display is generated dynamically from the schema. The data instance is rendered on the display per the display spec. The display spec has presenters for presentation. Additionally, the display spec can associate a widget, such as a button, with actions and operations. In this way, the user can be presented with information, possibly modify information, and take actions based on it.

The example above was limited to clearly illustrate some of the functionality, capability, and performance that the display specification may provide. As such one skilled in the art will appreciate that the same approach for functionality illustrated above may be extended to other data types, other forms of presentation, other actions, other operations, etc. Furthermore, the display specification is to be understood as capable of directly supporting all XML namespaces and providing the same level of support and functionality for XML-Schema Attributes as for XML-Schema Elements. For example, along with the TagName, ElementD also supports XPath constructs in the Name attribute. One such example: <ElementD Name=“//*/Tagname” Hide=“true”/>.

It is to be understood that a user may modify information related to the instance, the presentation, etc. This includes such well know operations as editing, adding, combining, deleting, selecting, outputting, inputting, etc.

For the sake of not obscuring the invention, reference has been made to viewing information related to an instance. One is to understand that more than one instance (instances) are possible. Reference was also made to a schema. One is to understand that more than one schema (schemas or schemata) are possible. Additionally, the use of the term view, viewing, etc. is not intended to limit its use to visual presentation. That is, view or viewing is intended to encompass, sight, sound, and the other senses, etc.

The discussion above has detailed only a few presenters. One skilled in the art will appreciate that may others are possible. Presenters may be, but are not limited to, the following.

DefaultTreePresenter—When specified for an Element, this creates a form out of all the non-hidden children of the Element. Much like a browser builds an HTML form. The form is automatically indented for tree structures.

ListPresenter—When specified for an Element, this presenter makes a list out of all the first non-hidden children of the Element.

TabbedTreePresenter—When specified for an Element, this presenter makes one tab out of all the first non-hidden children of the Element.

TreeStylePresenter—When specified for an element, this makes a tree out of all the non-hidden children rooted at the Element.

FloatingChildrenPresenter—When specified for an element, this makes Floating windows, one for each of the first non-hidden children of the element in yet another container window.

FormTreePresenter—Like the Default Tree Presenter: The difference is that this puts a separator bar after each of the first non-hidden child of the Element.

GridPresenter—When specified for an Element, this makes a row out of each of the first children and then makes column out of each of the second children. It will error if the second children don't match for each of the first children.

LayerPresenter—When specified for an Element, This makes the first generation of child nodes as buttons or menu bar items inside the presenter's main window. When the button representing a child node is clicked, the child's subtree is displayed in an auxilliary window.

MenuBarPresenter—When specified for an Element, it makes a Menu with the Element as the Root menu item.

SplitChildrenPresenter—When specified for an Element, it makes resizable adjacent windows for each of its children. An initial percentage can be specified for all of its children. The windows can be resized by the user by means of a resizing separator bar.

UnindentedFormPresenter—When specified for an Element, this makes a FormTreePresenter but without any indentation.

BorderlessRegionPresenter—This is same as SplitChildren presenter, but without any resizing separator bar.

The discussion above has also detailed only a few of the things supported by a presenter. Things supported by a presenter may be, but are not limited to, the following.

FontSizelncrement—Font size

FontName—Font name

FontStyle—Bold, Italic, Plain

Icon—The Icon to be used for the element

NoNewLine—Show two elements on the same line

AccessMode—read, readwrite

IsFolder—treat the element as a folder regardless of it having any child nodes or not.

Hide—Hide the element

HideChildren—Hide all children recursively

Editor—UI Component to be used for this:

Type—buttonwidget|checkboxwidget|chooseboxwidget|

comboboxwidget|labelwidget|strictComboBoxWidget|textwidget|

multiLineWidget|listboxwidget|strictListboxWidget|radioboxwidget.

Width—Large, Medium, Small

Height—Large, Medium, Small

Lineup—Lineup direction of Radio buttons/Check boxes

The discussion above has also detailed only a few of the things supported by an action. In general, an action is a means to specify which piece of code needs to be executed. Below in Backus-Naur Form (BNF) notation is one definition of what an action may be, but is not limited to.

InstanceGeneral ::=[a-zA-Z0-9:]+

InstanceKeywords ::=‘Active’|‘Parent’|‘Address’|‘Section’|‘Root’|‘Document’|‘My’

Instance ::=InstanceKeywords|InstanceGeneral

TypeExpr ::=‘(‘Type’)’

Type ::=‘Element’|‘Pane’|‘Presenter’|‘Screen’|‘Attribute’|‘Manager’

SourceNode ::=Instance|TypeExpr Instance

Source ::=SourceNode [. SourceNode]

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of communicating means or device whether local or remote, such as a LAN, a WAN, a system bus, etc.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, a Cathode Ray Tube (CRT), Liquid Crystal Display (LCD), a projection system, Television (TV), etc. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Reference has been made to the extensible markup language (XML). It is to be understood that XML is an evolving language and as such that those aspects consistent with the present invention may evolve over time. Such concepts, as for example, well formed which is one of the basic underpinnings of XML is not likely to change. However, on the other hand, support for other data types, such as streaming media may well be defined in the future. As such, the present invention's display specification is to be understood as encompassing these extensions. The XML specification and related material may be found at the website of the World Wide Web Consortium (W3C) located at http://www.w3.org.

Thus, a method and apparatus for automating the creation of display screens by using an XML schema that defines the data to be presented and using a display specification that defines how the data should be presented have been described.

What is claimed is:

1. A method comprising:
receiving a schema;
receiving an instance;
receiving a display specification; and
generating a display.

2. The method according to claim 1, wherein the display specification further comprises presenters, wherein the presenters determine how the instance appears on the display.

3. The method of claim 2 further comprising actions, wherein the actions modify the presenters.

4. The method of claim 3 wherein the actions further comprises functions based on the schema selected from the group consisting of type checking and structural validation.

5. The method according to claim 1, wherein the display specification further comprises presenters selected from the group consisting of tree, tabbed, list, and form.

6. The method according to claim 5, wherein the presenters may have embedded within them presenters.

7. The method according to claim 1, wherein the display specification further comprises display attributes selected from the group consisting of, font name, font style, font size, icons, access mode, folder, hiding, editor, lines, graphics, sound, and color.

8. The method of claim 1 wherein the schema has a structure selected from the group consisting of a tree and directed graph.

9. The method of claim 1 wherein the schema and instance are well formed.

10. The method of claim 1 wherein the schema and instance are compliant with the extensible markup language (XML).

11. The method of claim 1 wherein the display specification is compliant with the extensible markup language (XML).

12. The method of 11 wherein the display specification supports node selection from the group consisting of xmlns:Tagname, any:Tagname, any:any, and xpath language.

13. The method of claim 11 wherein the display specification supports instance display attributes selected from the group consisting of hide, hide children, and override.

14. A processing system comprising a processor, which when executing a set of instructions performs the method of claim 1.

15. A machine-readable medium having stored thereon instructions, which when executed performs the method of claim 1.

16. The method of claim 1 further comprising receiving information from the generated display.

17. The method of claim 16 wherein the information is from a user input.

18. The method of claim 1 wherein the display specification further comprises presenters, wherein presenters may receive information from a user input.

19. The method of claim 18 further comprising actions, wherein the actions are based on information received by the presenters.

20. A method comprising:
dynamically generating a user interface based upon an XML schema and a display specification.

21. The method of claim 20 wherein the display specification is well formed.

22. The method of claim 20 wherein the display specification is compliant with the extensible markup language (XML).

23. The method of claim 20 wherein dynamically generating the user interface is further based upon an XML data instance.

24. The method according to claim 20, wherein the display specification further comprises presenters, wherein the presenters determine how an XML data instance appears on the user interface.

25. The method of claim 24, wherein the display specification further comprises actions, wherein the actions modify the presenters.

26. The method according to claim 20, wherein the display specification further comprises presenters selected from the group consisting of tree, tabbed, list, and form.

27. The method according to claim 26, wherein the presenters may have embedded within them presenters.

28. The method according to claim 20, wherein the display specification further comprises display attributes selected from the group consisting of font name, font style, font size, icons, access mode, folder, hiding, editor, lines, graphics, sound, and color.

29. The method according to claim 20, wherein the display specification further comprises an editor type selected from the group consisting of forms, check boxes, radio buttons, check lists, combobox, drop down list, tables, text, label, text window, and graphics.

30. The method of claim 29 wherein the display specification supports restriction of any schema element and/or attribute.

31. A processing system comprising a processor, which when executing a set of instructions performs the method of claim 20.

32. A machine-readable medium having stored thereon instructions, which when executed performs the method of claim 20.

33. The method of claim 20 further comprising receiving information from the dynamically generated user interface.

34. The method of claim 20 wherein the information is from a user input.

35. The method of claim 20 wherein the display specification further comprises presenters, wherein presenters may receive information from a user input.

36. The method of claim 35 further comprising actions, wherein the actions are based on information received by the presenters.

37. The method of claim 36 wherein the actions may communicate to a destination selected from the group consisting of another program, a database, a user interface, a data instance, a processor, an XML instance, a schema, the XML schema, and the display specification.

38. An apparatus for dynamically generating a user interface comprising:
means for receiving a schema;
means for receiving an instance;
means for receiving a display specification; and
means for generating a display.

39. The apparatus of according to claim 38, wherein the display specification is well formed.

40. The apparatus of claim 38, wherein means for generating a display further comprises means for a user to view information related to the instance.

41. The apparatus of claim 40 further comprising means for the user to modify information related to the instance.

42. The apparatus of claim 38 wherein the schema and instance are compliant with the extensible markup language (XML).

43. A machine-readable medium having stored thereon information representing the apparatus of claim 38.

44. The apparatus of claim 38 further comprising receiving information from the display.

45. The apparatus of claim 44 wherein the information is from a user input.

46. The apparatus of claim 38 wherein the display specification further comprises presenters, wherein presenters may receive information from a user input.

47. The apparatus of claim 46 further comprising actions, wherein the actions are based on information received by the presenters.

48. The apparatus of claim 47 wherein the actions may communicate to a destination selected from the group consisting of another program, a database, a user interface, a data instance, a processor, an XML instance, a schema, the XML schema, and the display specification.

49. A system comprising a processor, which when executing a set of instructions, performs the following:
retrieves a schema;
retrieves data;
retrieves a display specification; and
generates a user interface.

50. The system of claim 49 wherein the user interface format is generated dynamically based substantially upon the schema.

51. The system of claim 49 wherein the user interface further comprises:
receiving a user input; and
modifying the data.

52. The system of claim 49 further comprising transferring a payment and/or a credit.

53. The system of claim 49 further comprising receiving information from the user interface.

54. The system of claim 53 wherein the information is from a user input.

55. The system of claim 49 wherein the display specification further comprises presenters, wherein presenters may receive information from a user input.

56. The system of claim 55 further comprising actions, wherein the actions are based on information received by the presenters.

57. The system of claim 56 wherein the actions may communicate to a destination selected from the group consisting of another program, a database, another user interface, a data instance, a processor, an XML instance, the schema, the data, the user interface, and the display specification.

58. An apparatus for dynamically generating a user interface comprising:
means for receiving an XML schema;
means for receiving an XML instance;
means for receiving an XML compliant display specification having actions and presenters;
means for generating a display based upon the display specification,
means for receiving a user input from the user interface, and
means for communicating to a program or processor through actions and presenters based upon the user input.
